(19) United States
(12) Patent Application Publication
(10) Pub. No.: US 2026/0055935 A1
(43) Pub. Date: Feb. 26, 2026

(54) FUNCTIONALLY GRADED STRUCTURES, METHODS, AND SYSTEMS FOR THERMAL MANAGEMENT

(71) Applicant: The University of Toledo, Toledo, OH (US)

(72) Inventors: Mohammad Elahinia, Toledo, OH (US); Saeedeh Vanaei, Toledo, OH (US); Shiva Mohajerani, Toledo, OH (US)

(73) Assignee: The University of Toledo, Toledo, OH (US)

(21) Appl. No.: 19/308,916

(22) Filed: Aug. 25, 2025

Related U.S. Application Data
(60) Provisional application No. 63/686,967, filed on Aug. 26, 2024.

(51) Int. Cl. F25B 21/00; B33Y 10/00; B33Y 80/00; C22F 1/00

(52) U.S. Cl. CPC F25B 21/00; B33Y 10/00; C22F 1/006; B33Y 80/00; F25B 2321/001

(57) ABSTRACT

Functionally graded structures, methods, and systems for thermal management are described.

### RELATED APPLICATIONS

This application claims priority to U.S. Provisional Application No. 63/686,967 filed under 35 U.S.C. § 111(b) on Aug. 26, 2024, the disclosure of which is incorporated herein by reference in its entirety.

### STATEMENT REGARDING FEDERALLY SPONSORED RESEARCH

This invention was made with no government support. The government has no rights in this invention.

### BACKGROUND

Cooling devices account for 20% of electricity consumption worldwide. Current refrigeration devices, cooling devices, and heat pumps are based on vapor-compression cycle (VCC), and their efficiency is below 50% of the Carnot thermodynamic cycle. Refrigeration devices are responsible for 7.8% of greenhouse gas emissions worldwide.

In alignment with the mandates of the Montreal Protocol and its Kigali Amendment, the global refrigeration sector is undergoing a transition away from high global warming potential (GWP) refrigerants toward environmentally benign alternatives. Despite their lower GWP, conventional natural refrigerants such as hydrocarbons (e.g., propane and butane), ammonia, and carbon dioxide are encumbered by significant operational and safety constraints. Specifically, hydrocarbons are highly flammable, ammonia introduces acute toxicity hazards, and CO₂ requires elevated operational pressures while demonstrating suboptimal thermodynamic performance in high-temperature climates.

To circumvent these limitations, considerable research has been directed toward the advancement of solid-state caloric cooling technologies. Unlike vapor-compression systems, caloric cooling platforms promise not only enhanced thermodynamic efficiency but also significant environmental benefits, as they eliminate the need for volatile or greenhouse gas-emitting working fluids.

The underlying principle of caloric cooling resides in the caloric effect: a reversible solid-state phase transformation triggered by an external field such as magnetic, electric, mechanical, or hydrostatic pressure resulting in an adiabatic temperature change and corresponding thermal exchange. These effects are being harnessed for the development of next-generation cooling systems with theoretical efficiencies projected to approach 60-70% of the Carnot limit.

Within this class of materials, elastocaloric materials (eCMs) have attracted significant attention due to their substantial latent heat typically exceeding 30 J/g as well as their mechanical tunability and relatively low material costs. Their intrinsic thermomechanical responsiveness positions them as highly favorable candidates for scalable, high-efficiency solid-state refrigeration systems. Over the past decade, elastocaloric technologies have emerged at the forefront of caloric research, with both the U.S. Department of Energy and the European Commission identifying them as the most promising path toward sustainable cooling. The strategic importance of elastocaloric refrigeration was further underscored by the World Economic Forum, which named it among the top 10 emerging technologies of 2024, signaling broad recognition of its transformative potential in global energy and climate contexts. Nevertheless, solid-state cooling/heating technologies have experienced limited market growth thus far due to a range of disadvantages.

In particular, solid-state cooling systems typically have lower effective cooling power compared to traditional VCC systems due to the nonuniform phase transformation of the thermoelastic material in regenerative mode. This limitation is due to the nonuniform temperature gradient between the heat sink and heat source, Consequently, each segment of the elastocaloric material experiences the thermodynamic cycle at a distinct local temperature (between the heat sink and heat source temperature). Owing to the intrinsic coupling between mechanical stress, temperature, and phase transformation behavior in shape memory alloys, the critical stress required to initiate and complete martensitic transformation increases with temperature. In practice, however, the eCM is typically subjected to a uniform mechanical load across its length. As a result, segments located at higher temperatures may not undergo complete phase transformation under the applied stress, resulting in incomplete utilization of the active material. This spatial non-uniformity in transformation diminishes the overall caloric output and adversely impacts the efficiency of the elastocaloric device.

Therefore, there is a pressing need to find novel technologies to improve systems for cooling and heating.

### SUMMARY

Provided herein is a method for fabricating a functionally graded structure, the method comprising forming a functionally graded structure from a shape memory alloy, and the functionally graded structure having a variation of transformation temperature along a length of the functionally graded structure or a variation of cross-sectional area along the length of the functionally graded structure, wherein the functionally graded structure is configured to be subjected to cyclic loading and unloading to induce phase transformations to promote near-uniform phase transformation across the functionally graded structure.

In certain examples, the variation of transformation temperature is configured so that a martensite peak temperature and an austenite peak temperature vary continuously or step-wise across the functionally graded structure by an amount corresponding to an expected system temperature span in a thermal management system.

In certain examples, the functionally graded structure has a first end and second end, the first end configured to be exposed to a first temperature, the second end configured to be exposed to a second temperature, the first temperature is higher than the second temperature, and wherein a lowest martensite start temperature occurs at the second end and a highest austenite start temperature occurs at the first end.

In certain examples, the variation of cross-sectional area is configured so that stress required to induce phase transformation, when the functionally graded structure is subjected to an expected system temperature span in a thermal management system, remains substantially constant along the length of the functionally graded structure.

In certain examples, the functionally graded structure has a first end and second end, the first end has a first cross-sectional area, the second end has a second cross-sectional area, and wherein the first cross-sectional area is less than the second cross-sectional area. In specific examples, the first cross-sectional area is configured to be exposed to a first temperature, the second cross-sectional area is configured to be exposed to a second temperature, and the first temperature is higher than the second temperature.

In certain examples, the functionally graded structure is formed using additive manufacturing.

In certain examples, the functionally graded structure is formed using laser powder bed fusion, directed energy deposition, or conventional powder metallurgy and melting processes. In specific examples, process parameters in laser powder bed fusion are varied by modulating laser power, scanning speed, or hatch spacing to create the variation of transformation temperature along the length of the functionally graded structure.

In certain examples, the functionally graded structure is an elongate member having a channel extending from a first end to a second end of the elongate member, the first end having a first outer diameter and the second end having a second outer diameter, and wherein the first outer diameter is different than the second outer diameter.

Further provided herein is a thermal management system comprising a functionally graded structure comprising a shape memory alloy, and the functionally graded structure having a variation of transformation temperature along a length of the functionally graded structure or a variation of cross-sectional area along the length of the functionally graded structure, wherein the functionally graded structure is configured to be subjected to cyclic loading and unloading to induce phase transformations to promote near-uniform phase transformation across the functionally graded structure.

In certain examples, the spatial variation of transformation temperature is configured so that a martensite peak temperature and an austenite peak temperature vary continuously or step-wise across the functionally graded structure by an amount corresponding to an expected system temperature span in the thermal management system.

In certain examples, the functionally graded structure has a first end and second end, the first end configured to be exposed to a first temperature, the second end configured to be exposed to a second temperature, the first temperature is higher than the second temperature, and wherein a lowest martensite start temperature occurs at the second end and a highest austenite start temperature occurs at the first end.

In certain examples, the spatial variation in cross-sectional area is configured so that stress required to induce phase transformation, when the functionally graded structure is subjected to an expected system temperature span in a thermal management system, remains substantially constant along the length of the functionally graded structure.

In certain examples, the functionally graded structure has a first end and second end, the first end has a first cross-sectional area, the second end has a second cross-sectional area, and wherein the first cross-sectional area is less than the second cross-sectional area. In specific examples, the first cross-sectional area is configured to be exposed to a first temperature, the second cross-sectional area is configured to be exposed to a second temperature, and the first temperature is higher than the second temperature.

In certain examples, the functionally graded structure is an elongate member having a channel extending from a first end to a second end of the elongate member, the first end having a first outer diameter and the second end having a second outer diameter, and wherein the first outer diameter is different than the second outer diameter.

In certain examples, the functionally graded structure is an elongate member having a channel extending from a first end to a second end of the elongate member, the elongate member has an inner diameter and an outer diameter, and wherein the inner diameter remains constant along the elongate member and the outer diameter varies along the elongate member.

In certain examples, the thermal management system includes an active regenerator comprising the functionally graded structure and a fluid network, wherein cyclic loading and heat transfer steps are synchronized such that near-uniform phase transformation is achieved during each cycle. In specific examples, the active regenerator includes a shell-and-tube and/or parallel plates configured such that a transformation temperature gradient aligns with the direction of fluid flow from a heat source to a heat sink.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Functionally graded structure according to one or more embodiments.

FIG. 2: Functionally graded structure according to one or more embodiments.

FIG. 3: Thermal management system according to one or more embodiments.

FIG. 4: Graph of superelasticity which indicated the effect of load on crystalline structure.

FIG. 5: Graph illustrating a stress induced phase change releasing latent heat in a thermoelastic cooling structure, according to one or more embodiments of the disclosed subject matter.

FIG. 6A: Functionally graded structure subject to axial loading considering variation of transformation temperature, according to one or more embodiments.

FIG. 6B: Functionally graded structure subject to axial loading considering variation of transformation temperature, according to one or more embodiments.

FIG. 7A: Schematic of a functionally graded structure in heat transfer fluid cycle under loading condition, according to one or more embodiments.

FIG. 7B: Graph of stress-strain (superelastic) response at different ambient temperatures of NiTi alloy from the phenomenological model, according to one or more embodiments.

FIG. 8: Graph of the transformation temperature variation along the functionally graded structure based on the Clausius-Clapeyron relation, according to one or more embodiments.

FIG. 9: Graph of the stress-temperature plot in a functionally graded structure, according to one or more embodiments.

FIG. 10: Graph of the stress-temperature plot of the variation of cross-sectional area in a functionally graded structure based on the Clausius-Clapeyron relation, according to one or more embodiments.

FIG. 11A: Schematic of a functionally graded structure having a variation of cross section area along the functionally graded structure to justify the applied stress distribution in a heat transfer fluid system under loading condition, according to one or more embodiments.

FIG. 11B: Graph of outer radius vs. temperature curve derived from Equation (15) based on the corresponding stress, according to one or more embodiments.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Functionally graded structures are described as having a variation of temperature along a loading direction or a variation of cross-sectional area along a loading direction of the functionally graded structure. It should be appreciated that the loading direction can include a length and/or width of the functionally graded structures.

The described functionally graded structures, methods, and systems for thermal management can relate to heat exchange systems, as well as to cooling and heat exchange systems based on thermoelastic principles. These structures, methods, and systems can address the demand for compact, cost-effective, high-efficiency, and environmentally friendly cooling technologies. This functionally graded structure can be used for solid-state cooling and heating purposes formed from an elastocaloric material, along with associated design methodologies. Systems can incorporate functionally graded (FG) elastocaloric materials either via compositional grading or geometric grading, to enhance phase transformation uniformity. By optimizing material utilization, the FG design may increase the coefficient of performance (COP) and specific cooling power (SCP) of the system.

As described herein, a method for fabricating a functionally graded structure 100 can comprise forming a functionally graded structure 100 from a shape memory alloy, and the functionally graded structure 100 having a variation of transformation temperature 102 along a length of the functionally graded structure 100 or a variation of cross-sectional area 104 along the length of the functionally graded structure 100. The functionally graded structure 100 can be configured to be subjected to cyclic loading and unloading to induce phase transformations to promote near-uniform phase transformation across the functionally graded structure 100.

The functionally graded structure 100 can comprise shape-memory alloys that exhibit a thermoelastic effect including but not limited to, NiTi-based alloys, Cu-based alloys (CuZnAl alloys (e.g., Cu 65-70 wt % and Al 13-23 wt %), CuAlNi alloys (e.g., Cu 80-85 wt % and Al 12-15 wt %), CuZnNi alloys, CuAlMn, CuZn alloys, CuSn alloys, and CuAlBe alloys), Fe-based alloys (FePd alloys, FeRh alloys), AuCd alloys, NiMnGa alloys, derivative alloys thereof, or combinations thereof. In certain examples, the shape-memory alloy is nitinol (i.e., NiTi alloy with 55 wt % of Ni).

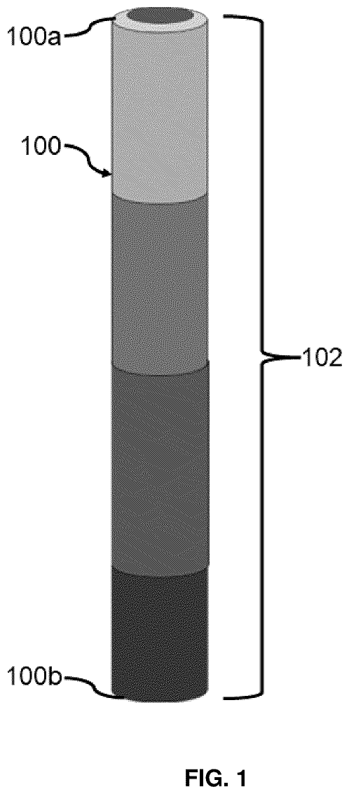

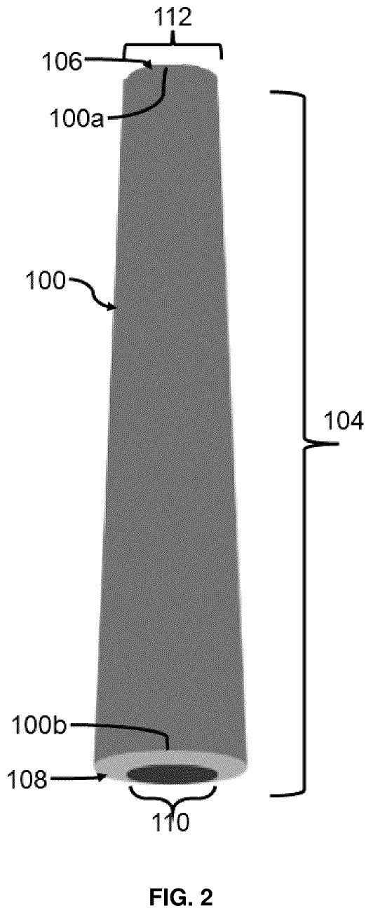

With reference to FIGS. 1-2, the functionally graded structure 100 can include a first end 100a and a second end 100b. The functionally graded structure 100 can be an elongate member, e.g., a tube. However, it should be appreciated that other types of geometries may incorporate the disclosed thermoelastic material structure and methods of use thereof according to one or more embodiments. In certain examples, the functionally graded structure 100 is an elongate member having a channel extending from the first end 100a to the second end 100b.

As shown in FIG. 1, the variation of transformation temperature 102 can be spatially tailored along the length of functionally graded structure 100 to achieve higher efficiency. By modulating the transformation temperature, the functionally graded structure 100 is engineered to undergo phase transformation more uniformly across a thermal gradient, thereby optimizing heat exchange performance and mechanical efficiency.

In certain examples, the variation of transformation temperature 102 can be configured such that segments of the functionally graded structure 100 exposed to higher ambient temperatures require correspondingly higher transformation stresses, and vice versa. This facilitates full utilization of the material's caloric potential during the forward (austenite-to-martensite) transformation. The variation of transformation temperature 102 can be further configured to optimize the reverse (martensite-to-austenite) transformation by ensuring that the critical stress for transformation aligns with regions of highest reverse transformation temperature (austenite start temperature, Aₛ), thereby facilitating effective heat absorption.

Non-limiting examples of achieving the variation of transformation temperature 102 can include fabricating the functionally graded structure 100 by additive manufacturing processes, laser powder bed fusion, directed energy deposition, or conventional powder metallurgy and melting processes. For example, the variation of transformation temperature 102 can be achieved by optimizing process parameters in the laser powder bed fusion process. Non-limiting examples of the process parameters include laser power (e.g., increase to lower transformation temperature or decrease to raise transformation temperature), scanning speed (e.g., faster to lower transformation temperature or slower to raise transformation temperature), and hatch spacing (wider spacing to lower transformation temperature or narrower spacing to raise transformation temperature).

In another example, the variation of transformation temperature 102 is controlled by adjusting alloy composition during wire direct energy deposition process. In certain examples, the variation of transformation temperature 102 is controlled by spatially resolved heat treatment employed to locally modify the transformation temperature of each segment of the functionally graded structure 100 corresponding to the local temperature.

The spatial variation of transformation temperature 102 can be configured so that a martensite peak temperature and an austenite peak temperature vary continuously or step-wise across the functionally graded structure 100 by an amount corresponding to an expected system temperature span in a thermal management system.

In certain examples, the first end 100a is configured to be exposed to a first temperature. The second end 100b is configured to be exposed to a second temperature. The first temperature is higher than the second temperature, e.g., the first temperature is a higher ambient temperature than the second temperature. In this configuration, the lowest martensite start temperature can occur at the second end 100b and the highest austenite start temperature occurs at the first end 100a.

Another approach to enhance the efficiency of solid-state cooling or heating systems involves the implementation of a graded geometry, specifically through the variation of cross-sectional area 104 along the length of the functionally graded structure 100, as shown in FIG. 2. This structural adaptation is designed to mitigate the effects of nonuniform phase transformation that arise due to the imposed temperature gradient between the heat sink (T_{c}) and heat source (Tₕ) under regenerative operation. As thermal cycling establishes a spatially dependent temperature field across the functionally graded structure 100, the resulting phase transformation response becomes similarly nonuniform. In other words, the variation of cross-sectional area 104 compensates for the local transformation stress requirements imposed by the thermal gradient.

According to the Clausius-Clapeyron relation, the stress required to initiate martensitic transformation increases with temperature. Thus, a uniform applied stress may result in partial transformation at higher temperatures or excessive stress at lower temperatures, potentially causing plastic deformation. As disclosed herein, local modulation of the cross-sectional area provides a means to tune the effective stress along the functionally graded structure 100, thereby achieving more uniform transformation and mitigating mechanical degradation.

The variation of cross-sectional area 104 can be configured so that stress required to induce phase transformation, when the element is subjected to an expected system temperature span in a thermal management system, remains substantially constant along the length of the functionally graded structure 100.

With reference to FIG. 2, the first end 100a can have a first cross-sectional area 106, and the second end 100b can have a second cross-sectional area 108. The variation of cross-sectional area 104 can be achieved by adjusting the functionally graded structure 100 so that the first cross-sectional area 106 is less than the second cross-sectional area 108. The first cross-sectional area 106 can be configured to be exposed to the first temperature and the second cross-sectional area 108 can be configured to be exposed to the second temperature. The first temperature is higher than the second temperature, e.g., the first temperature is a higher ambient temperature than the second temperature.

While still referring to FIG. 2, the elongate member can have an inner diameter 110 and an outer diameter 112. The variation of cross-sectional area 104 can be achieved by adjusting the functionally graded structure 100 so that the inner diameter 110 remains constant along the elongate member and the outer diameter 112 varies along the elongate member.

Non-limiting examples of achieving the variation of cross-sectional area 104 can include fabricating the functionally graded structure 100 by additive manufacturing processes, laser powder bed fusion, directed energy deposition, or conventional powder metallurgy and melting processes. Conventional approaches such as precision machining or laser cutting can also be employed.

The functionally graded structure 100 can have the variation of transformation temperature 102 along a length of the functionally graded structure 100 (e.g., FIG. 1) or the variation of cross-sectional area 104 along the length of the functionally graded structure 100 (e.g., FIG. 2), as described herein. The functionally graded structure 100 can be utilized as an active solid-state refrigerant. A stress-induced phase transformation from the high-temperature austenitic phase to the low-temperature martensitic phase results in the release of latent heat. The critical stress required to initiate this transformation is strongly dependent on the material's transformation temperature, as governed by the Clausius-Clapeyron relation. The functionally graded structure 100 facilitates improved exploitation of the elastocaloric effect, enhancing both the COP and SCP of regenerative-mode solid-state cooling and heating devices over a broad range of operational conditions.

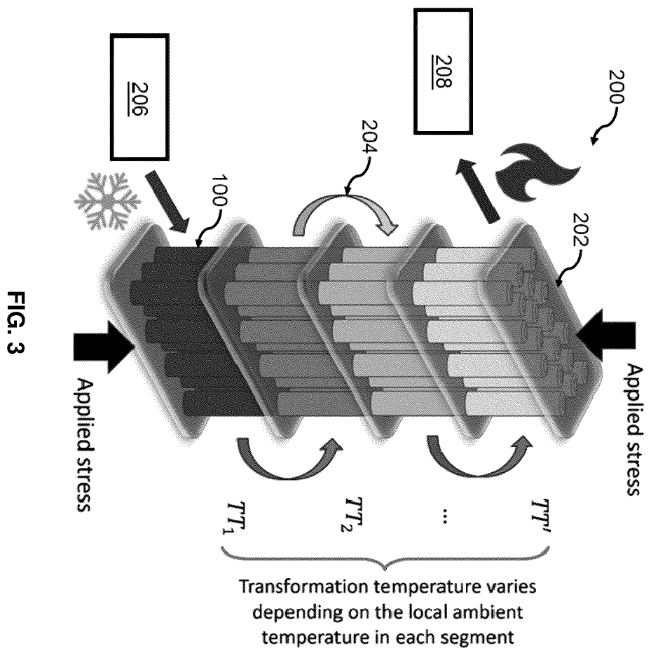

With reference to FIG. 3, a thermal management system 200 can comprise the functionally graded structure 100 comprising the shape memory alloy. The functionally graded structure 100 can have the variation of transformation temperature 102 along the length of the functionally graded structure 100 or the variation of cross-sectional area 104 along the length of the functionally graded structure 100. The functionally graded structure 100 is configured to be subjected to cyclic loading and unloading to induce phase transformations to promote near-uniform phase transformation across the functionally graded structure 100.

In certain examples, the thermal management system 200 includes an active regenerator 202 comprising the functionally graded structure 100 and a fluid network 204. Each cyclic loading and heat transfer steps are synchronized such that near-uniform phase transformation is achieved during each cycle. The active regenerator 202 can include a shell-and-tube and/or parallel plate configuration, for example, as shown in FIG. 3. This configuration can include aligning the transformation temperature gradient with the direction of fluid flow from a heat source 206 to a heat sink 208. The operation of thermal management system 200 follows an active elastocaloric regeneration cycle including loading, holding, unloading, and recovery stages, and the functionally graded structure 100 enables a higher specific cooling power compared to uniform elements

### Examples

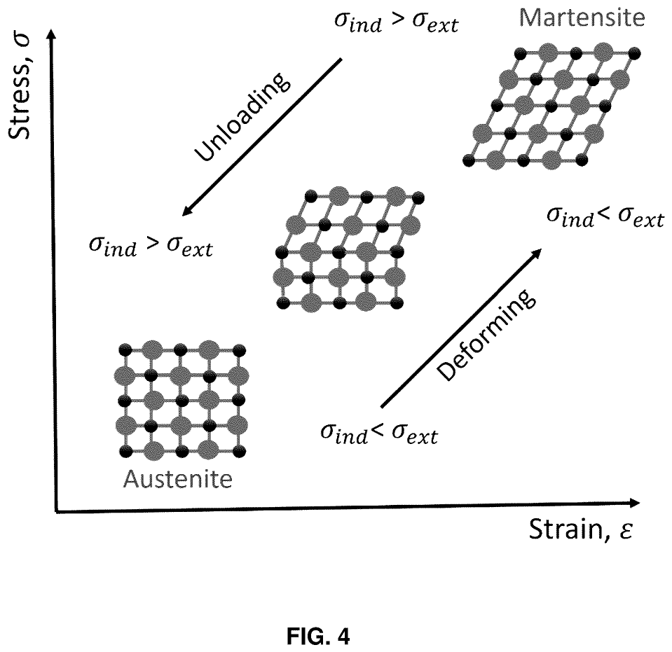

As used interchangeably herein, thermoelastic and elastocaloric refer to a type of material that releases latent heat in response to a stress-induced phase transition from a first crystalline state (austenite) to a second crystalline state (martensite) as shown in FIG. 4. Such a phase transition may be reversible so that upon relaxation of the stress the material absorbs a corresponding amount of latent heat in transitioning from the second crystalline state back to the first crystalline state. Shape-memory alloys that exhibit a thermoelastic effect can include, but are not limited to, NiTi-based alloys, Cu-based alloys (CuZnAl alloys (e.g., Cu 65-70 wt % and Al 13-23 wt %), CuAlNi alloys (e.g., Cu 80-85 wt % and Al 12-15 wt %), CuZnNi alloys, CuAlMn, CuZn alloys, CuSn alloys, and CuAlBe alloys), Fe-based alloys (FePd alloys, FeRh alloys), AuCd alloys, NiMnGa alloys, and derivative alloys thereof. For example, in one or more embodiments, the shape-memory alloy is nitinol (i.e., NiTi alloy with 55 wt % of Ni).

This release and absorption of heat can be used by a system to perform heating, cooling, or both heating and cooling. Thus, although embodiments are described herein as a component in the air-conditioning/cooling/refrigeration system or as delivering a cooling function, such embodiments can also be used as a component in the heating system or to deliver a heating function, as will be readily apparent to one of ordinary skill in the art.

The elastocaloric effect can potentially deliver a higher adiabatic temperature as compared to other cooling modalities, thereby allowing the use of thermoelastic materials as a single stage cycle for air-conditioning and refrigeration applications. Moreover, thermoelastic materials may exhibit superior material performance as compared to other solid-state cooling modalities. The thermoelastic materials can be used for power cycles (where the driving potential is the temperature difference) or applied reversely for thermoelastic cooling/heat cycles (where applied stress induces heating).

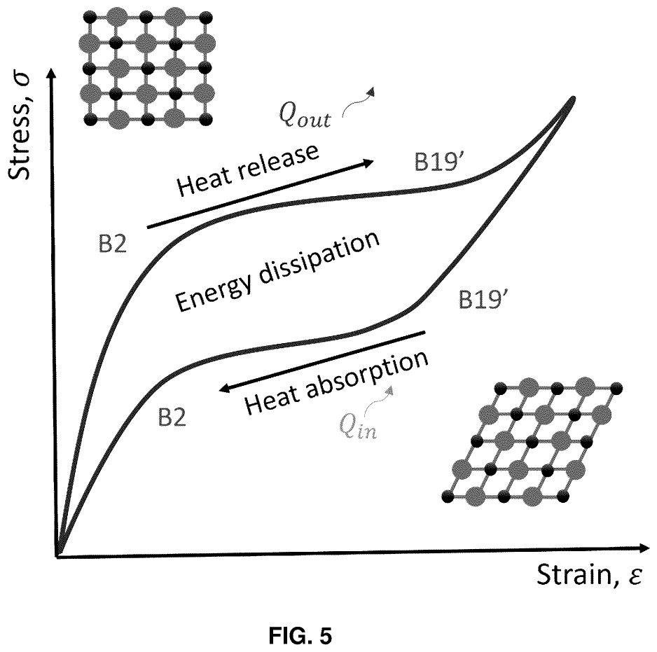

In a cooling/heat cycle, the useful cooling/heating effect is the result of the associated latent heat released during the stress-induced phase change process, which causes the material to transition from a first crystalline phase to a second crystalline phase. For example, FIG. 4 shows a shape-memory alloy material in a first crystalline phase (austenite). When the material is subjected to an external stress (ϕₑₓₜ) that exceeds the phase change stress (σ_{ind}) for the given system temperature, the austenite crystal structure transforms to a martensite crystal structure while simultaneously releasing latent heat that increases the material's temperature during the adiabatic phase change process, as shown by the inset graph in FIG. 5. Cooling can take place when the external stress (σₑₓₜ) is less than the phase change stress (σ_{ind}). As stress decreases below the threshold, the material transitions back to the first crystalline state, the austenite phase, while simultaneously absorbing ambient heat from itself and the environment, thereby reducing its temperature and delivering a cooling effect.

External stress (ϕₑₓₜ) can be tensile or compressive stress. In one or more embodiments, compression is used instead of tension since compression may serve to enhance the strength of the shape-memory alloy by enlarging its cross-section. In addition, the stress-strain hysteresis of the compression process may be less than that of tension so that less work input may be required.

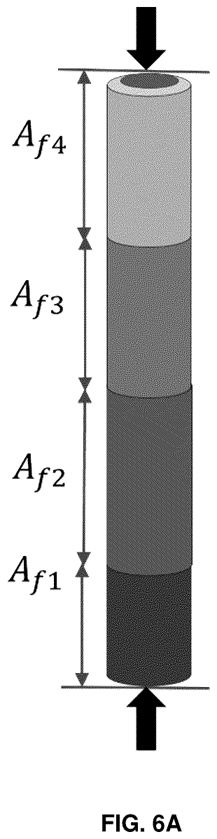

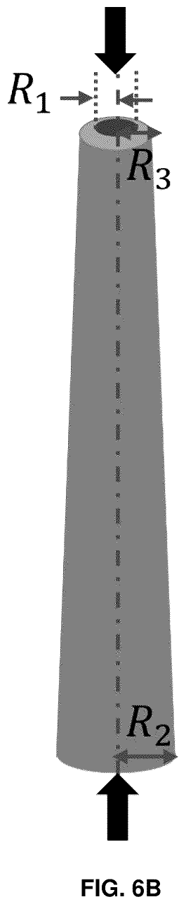

In one or more embodiments, the thermoelastic heating/cooling structural element can be achieved in the shape of a tube (i) with variation of transformation temperature along the length or (ii) with variation of cross-sectional area along the length as depicted in FIG. 6. The process of the design and methodology are illustrated in the Vanaei et al. (2025). paper entitled “Toward Advancing Elastocaloric Performance in Shape Memory Alloys Through Additive Manufacturing: Novel Conceptual Designs and Preliminary Insights”, which is incorporated by reference in its entirety.

In one or more embodiments, the thermoelastic heating/cooling structural element can be achieved in the shape of a tube with variation of transformation temperature along the length. FIG. 6A depicts an exemplary solid-state cooling tube-based structure with the variation of transformation temperature along its length. The design promotes a uniform phase transformation when the component is subjected to regenerative mode. A solid-state cooling component is usually subjected to a cyclic loading condition between a heat sink and heat source. The side of the component surrounded by lower ambient temperature required less phase change stress, while the other side, surrounded by a higher ambient temperature, needed a higher level of phase change stress.

Although the tube-based structure has been specifically discussed herein, embodiments of the disclosed subject matter are not necessarily limited thereto. Indeed, other types of geometries may incorporate the disclosed thermoelastic material structure and methods of use thereof according to one or more contemplated embodiments.

In one or more embodiments, the thermoelastic heating/cooling structural element can be achieved in the shape of a tube with variation of cross-section along the length as depicted in FIG. 6B. The nonuniform temperature gradient causes a nonuniform phase transformation in the component. The design promotes a uniform phase transformation when the component is subjected to regenerative mode. This justification can be achieved through cross-sectional change. Although the tube-based structure has been specifically discussed herein, embodiments of the disclosed subject matter are not necessarily limited thereto. Indeed, other types of geometries may incorporate the disclosed thermoelastic material structure and methods of use thereof according to one or more contemplated embodiments.

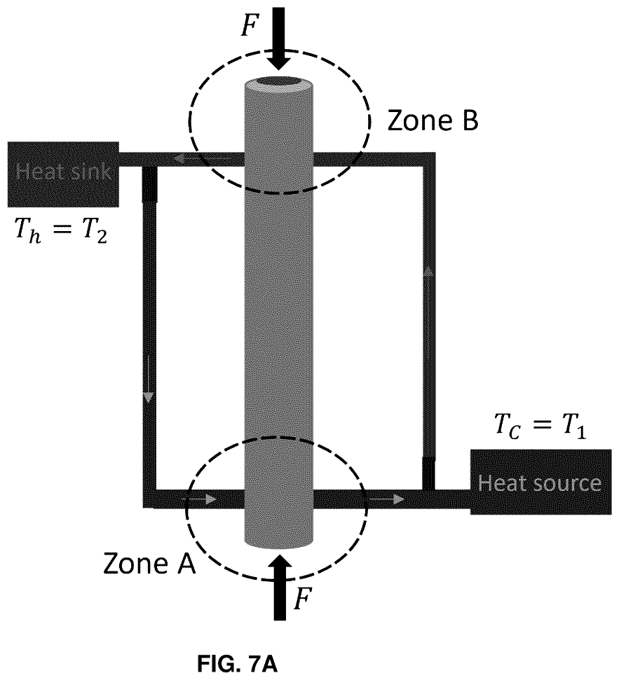

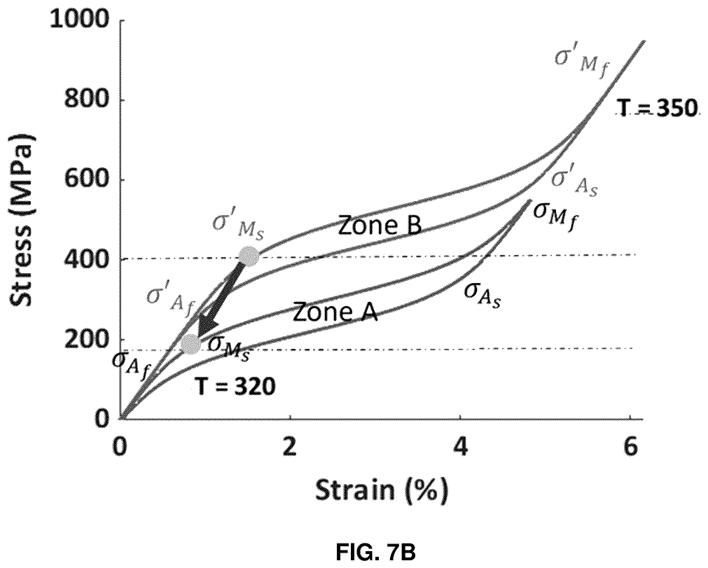

FIG. 7A illustrates a schematic of a thermoelastic tube in a heat transfer fluid cycle under loading conditions that can provide heating and cooling. Zones A and B are surrounded by the lower ambient temperature of T1 and the higher ambient temperature of T2, respectively. The required stress level at a certain temperature to transform the material can be identified by the phenomenological model. The corresponding stress-strain responses of Zones A and B have been illustrated in FIG. 7B in accordance with the Tanaka-type phenomenological model. The constant force (loading work) of F can alternately stress Zones A and B, such that Zone A at a lower ambient temperature experiences a lower stress and Zone B at a higher ambient temperature experiences a higher stress. The gradient of stress causes the nonuniform transformation along the tube. If the working load exceeds the lower stress, the stress-induced transformation causes plastic deformation, and otherwise, if the working load fails to reach the higher stress, the material experiences only partial elastic deformation.

Equation (1) describes the strain-stress-temperature relation to predict the stress-strain diagram at a certain temperature, as shown in FIG. 7B, and is given by:

$$ε ( σ , T ) = \frac{{ε}_{tran}}{2} tanh ( a . ( σ - {σ}_{0} ( T ) ) ) + \frac{σ}{E} + \frac{{ε}_{t r a n}}{2} \qquad ( 1 )$$

$${a}_{f} = \frac{2.9444}{{C}_{f} ( {M}_{s} - {M}_{f} )} \qquad ( 1 a )$$

$${a}_{r} = \frac{2.9444}{{C}_{r} ( {A}_{f} - {A}_{s} )} \qquad ( 1 b )$$

$${σ}_{0 , f} ( T ) = {C}_{f} ( T - {M}_{p} ) \qquad ( 1 c )$$

$${σ}_{0 , r} ( T ) = {C}_{r} ( T - {A}_{p} ) \qquad ( 1 d )$$

where εₜᵣₐₙ is the transformation strain, E is the elastic Young's moduli of the austenitic and martensitic phases (here it is assumed that both moduli are the same, which fits well for the evaluated materials in this work), while a_{f} and aᵣ represent the slope of the transformation plateau [see Equations (1a) and (1b)] and σ₀ is the critical stress as a function of the temperature in the phase diagram [see Equations (1c) and (1d)]. Mₛ, Mₚ, M_{f}, Aₛ, Aₚ, A_{f}, are six transformation temperatures, namely martensitic start, martensitic peak, martensitic finish, austenitic start, austenitic peak, and austenitic finish temperature, respectively. The two coefficients, C_{f} and Cᵣ, represent the Clausius-Clapeyron coefficients for forward and reverse transformation defined as the derivative of the critical transformation stress (stress at the middle of the transformation plateau at the particular temperature) over the temperature

$$C = {( \frac{d σ}{d T} )}_{c r} ,$$

which are usually constant values. These eight properties, together with the elastic moduli (E) and the transformation strain (εₜᵣₐₙ), are the experimentally obtained input parameters for the model.

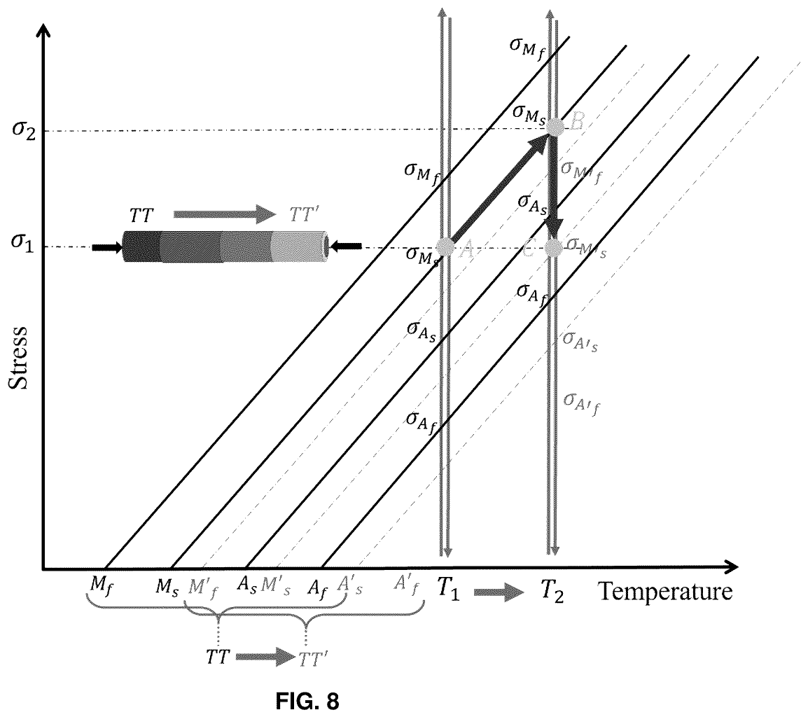

FIG. 8 illustrates an alternative tube with variation of transformation temperature along the length to achieve a uniform phase transformation surrounded by a temperature span during the loading condition. The concept of the innovative design has been discussed using the basic thermodynamic relation, specifically Clausius-Clapeyron relation.

The functionally graded shape memory tube can be designed to determine the required variation in transformation temperature along the tube. A non-uniform stress-induced phase transformation occurs along the tube due to the temperature span between its two ends. The ambient temperature at the highest level requires higher stress to be sure the martensitic transformation is completed. For elastocaloric effect performance, it is ideal that the entire elastocaloric material transforms uniformly. According to the Clausius-Clapeyron relation, if the same level of stress is applied at a higher temperature, the only way to ensure that the condition will satisfy the mathematical equation is to transfer the transformation temperature (TT) to a higher value as the interaction of the TT line with the temperature line stays at a lower stress level, as shown in FIG. 8.

The functionally graded shape memory structure can enhance the performance of the thermoelastic heating/cooling element in the presence of a thermal gradient, which is inevitable, especially when the elastocaloric device operates in the regenerative mode.

The tube can have the same geometry along its length, while the transformation temperatures of its sections vary. This is possible by adjusting the process parameters in the laser powder bed fusion process, as the tube is manufactured layer by layer from bottom to top.

Varying the A_{f} along the length of the tube can be determined by the phenomenological model described above. FIG. 6A illustrates that the end of the tube exposed to higher ambient temperatures required more stress to achieve a fully recoverable transition. An unbalanced stress level along the tube leads to the formation of a non-uniform martensitic transformation. It means that martensite transformation has begun in some areas of the tube, while stress levels in others are insufficient to initiate martensitic transformation. This means the stress required for a fully recoverable transformation will not be achieved at once in the existence of a temperature span unless the transformation temperature of the tube at a higher ambient temperature rises, as illustrated in FIG. 8. As can be seen in FIG. 8, at the end of the tube, surrounded by the ambient temperature of T₁, the transformation starts at σ_{Ms} with the magnitude of σ₁ (point A). However, at the other end of the tube surrounded by the higher ambient temperature of T₂, the transformation starts at σ_{Ms} with the magnitude of σ₂ (point B) while the desired stress level should be at σ₁ (point C).

The design is toward transferring the thermoelastic material uniformly at the same amount of stress σ₁ at the higher temperature ambient to determine the extent to which the transformation temperature along the tube needs to increase.

The methodology taught herein is to design a functionally graded shape memory structure by identifying the transformation temperature range. It can be assumed that the initial stress value of forward transformation Equation (1c) at a lower temperature of T₁ should be equal to that at an elevated temperature T₂ as follows:

$${σ}_{0 , f} ( {T}_{1} ) = {σ}_{0 , f} ( {T}_{2} ) \qquad ( 2 )$$

By substituting Equation (1c) in Equation (2), considering the slope of the curve (C_{f}) stays the same:

$$( {T}_{1} - {M}_{P 1} ) = ( {T}_{2} - {M}_{p 2} ) \qquad ( 3 )$$

where M_{P1} and M_{P2} are the martensitic peak at the lower and upper end of the tube, respectively. From Equation (3), Mₚ₂ can be calculated as:

$${M}_{p 2} = {T}_{2} - ( {T}_{1} - {M}_{P 1} ) \qquad ( 4 )$$

Following the same procedure, we can obtain Aₚ₂ as:

$${A}_{p 2} = {T}_{2} - ( {T}_{1} - {A}_{P 1} ) \qquad ( 5 )$$

where Δ_{P1} and A_{P2} are the austenitic peak at the lower and upper end of the tube, respectively. It should be noticed from Equation (1a) and (1b) that at different temperatures the difference between austenite finish and start (A_{f}-Aₛ) and martensite start and finish (Mₛ−M_{f}) are always constant. By considering that Mₚ₂ is the midpoint between Mₛ₂ and M_{f2} and Aₚ₂ is the midpoint between Aₛ₂ and A_{f2} we can calculate the value for the TT as:

$${M}_{s 2} = {M}_{p 2} + \frac{( {M}_{s} - {M}_{f} )}{2} \qquad ( 6 )$$

$${A}_{s 2} = {A}_{p 2} - \frac{( {A}_{f} - {A}_{s} )}{2} \qquad ( 7 )$$

$${M}_{f 2} = {M}_{p 2} - \frac{( {M}_{s} - {M}_{f} )}{2} \qquad ( 8 )$$

$${A}_{f 2} = {A}_{p 2} + \frac{( {A}_{f} - {A}_{s} )}{2} \qquad ( 9 )$$

where Mₛ₂, M_{f2} Aₛ₂, and A_{f2} are the martensite start, martensite finish, austenite start and austenite finish at the upper end of the tube, respectively. It should be noticed that loading must be reached the stress level of the section with the lowest Mₛ to be sure that the component with different transformation temperatures will transform fully to martensite. After the transformation along the tube is completed, unloading must be applied down to the stress level of the section with the highest Aₛ.

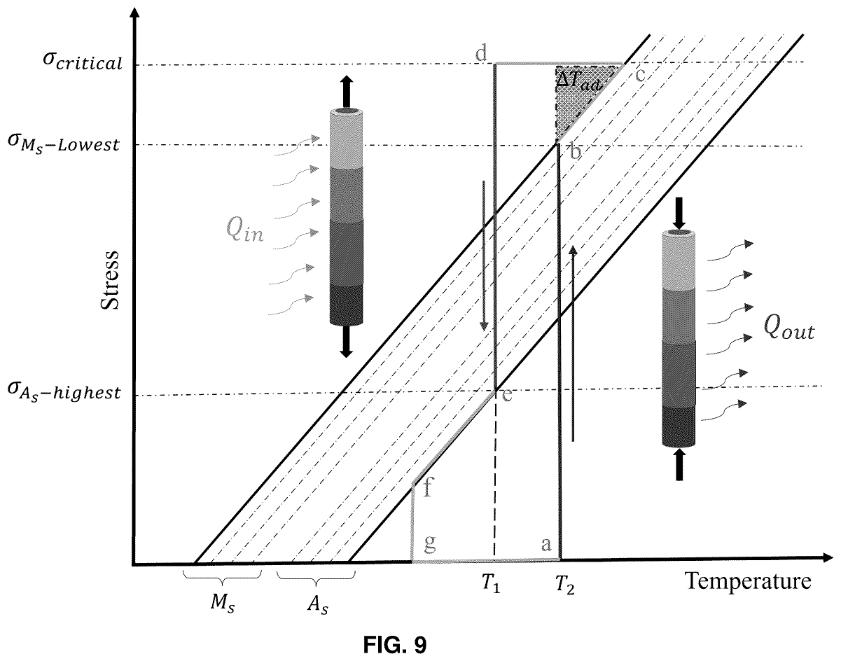

As illustrated in FIG. 9, the SMA refrigeration cycle starts by applying the load between the ambient temperature of T₂ and the cooling temperature of T₁. At the start point of (a), the tube with a variation of A_{f} is fully austenite (at zero stress level). It should be noticed that loading must be reached the stress level of the section with the lowest Mₛ to be sure that the component with different transformation temperatures will transform fully to martensite (by point b). Due to the heat explosion, the adiabatic temperature change (T₂+ΔT_{ad}) can be observed (points b to c). The tube will reach the critical stress level (points c to d). After the transformation along the tube is completed, unloading must be applied down to the stress level of the section with the highest Aₛ (point e). Again, the transformation toward a fully austenite structure will be completed (f-g to a) toward the ambient temperature (T₂−ΔT_{ad}).

The other alternative disclosed herein, as illustrated in FIG. 5B, is to change the cross-section of the tube, while maintaining the same base material transformation temperature along its length. This feature results in a profile of stresses along the length when the tube is loaded axially. At a constant load, lower stress will occur in the tube where the ambient temperature is higher. Since the transformation temperatures are stress-dependent, this design will create a gradient of effective transformation temperatures along the length. In other words, a larger cross section and lower stress mean effectively lowering local transformation temperature and achieving a similar outcome as the first design in improving electrocaloric effect efficiency. With both designs, the aim is to have the same distance between the local transformation temperature and the ambient temperature, as shown in FIG. 7B. These designs are toward increasing elastocaloric effect by improving phase transformation behavior and enhancing system efficiency by increasing temperature span. Moreover, additive manufacturing benefits the fabrication of this concept by eliminating the need to join the parts with different TTs. By avoiding joints, we remove a favorable location for failure, especially since the part will be used in high fatigue cycles.

Another methodology is taught herein to reach a uniform phase transformation along the tube that is exposed to a range of ambient temperatures by adjusting the effective stress along the length. As can be seen in FIG. 6A due to the temperature span in the heat transfer fluid system, non-uniform phase transformation takes place along the tube. The corresponding respond of the tube under loading can be seen in FIG. 6A. The upper cross section area at higher ambient temperature (T₂=Tₕ) requires more stress to transform based on the stress-strain curve shown in FIG. 6B. While the lower cross section area in contact with the lower ambient temperature needs lower values of stress.

In the present methodology taught herein, it is assumed that the inner radius R₁ of the tube is constant while the outer radius R₂→R₃ needs to be changed based on the need to a uniform phase transformation. For the upper cross section with a lower ambient temperature T₁, the applying force can be calculated as:

$$F = {σ}_{1} \cdot π ( {R}_{2}^{2} - {R}_{1}^{2} ) \qquad ( 10 )$$

As the applied force along the tube is constant, for the lower cross section with higher ambient temperature T₂:

$$F = {σ}_{2} \cdot π ( {R}_{3}^{2} - {R}_{1}^{2} ) \qquad ( 11 )$$

As Equation (10) is equal to Equation (11), the outer radius R₃ can be obtained as:

$${R}_{3} = \sqrt{\frac{{σ}_{1} ( {R}_{2}^{2} - {R}_{1}^{2} )}{{σ}_{2}} + {R}_{1}^{2}} \qquad ( 12 )$$

α₁ and α₂ in Equation (12) are the critical stresses for completing the forward transformation at lower and higher temperature of T_{c} and Tₕ, respectively, as shown in FIG. 9. Also, the relation between the stress-temperature can be written as follows according to the Clausius-Clapeyron equation:

$${C}_{f} = {( \frac{d σ}{d T} )}_{c r} = \frac{{σ}_{2} ( {T}_{2} ) - {σ}_{1} ( {T}_{1} )}{{T}_{2} - {T}_{1}} \qquad ( 13 )$$

Using Equation (13), the relation between α_{Ms1} and σ_{Ms2} as the function of temperature can be written as:

$${σ}_{M s 2} ( {T}_{2} ) = {C}_{f} ( {T}_{2} - {T}_{1} ) + {σ}_{1} ( {T}_{1} ) \qquad ( 14 )$$

By substituting Equation (14) in Equation (13), the relation between the outer radius, stress and temperature can be written as:

$${R}_{3} = \sqrt{\frac{{σ}_{1} ( {T}_{1} ) ( {R}_{2}^{2} - {R}_{1}^{2} )}{{C}_{f} ( {T}_{2} - {T}_{1} ) + {σ}_{1} ( {T}_{1} )} + {R}_{1}^{2}} \qquad ( 15 )$$

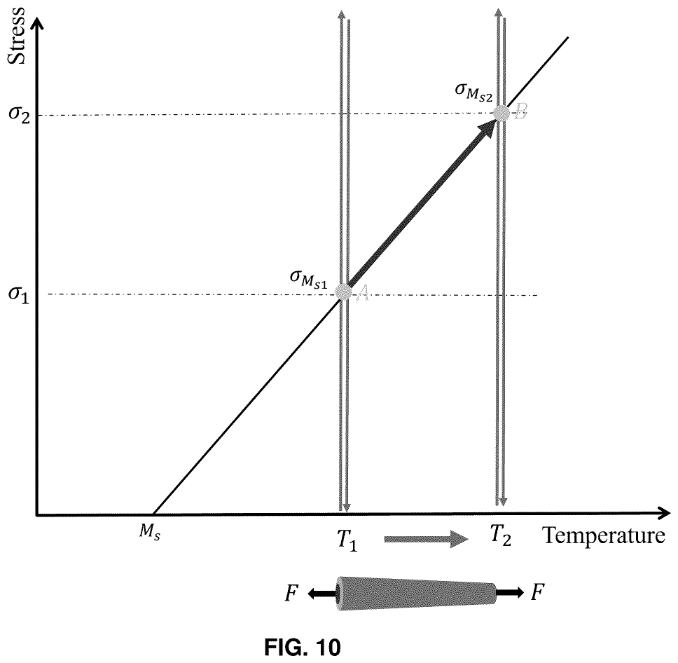

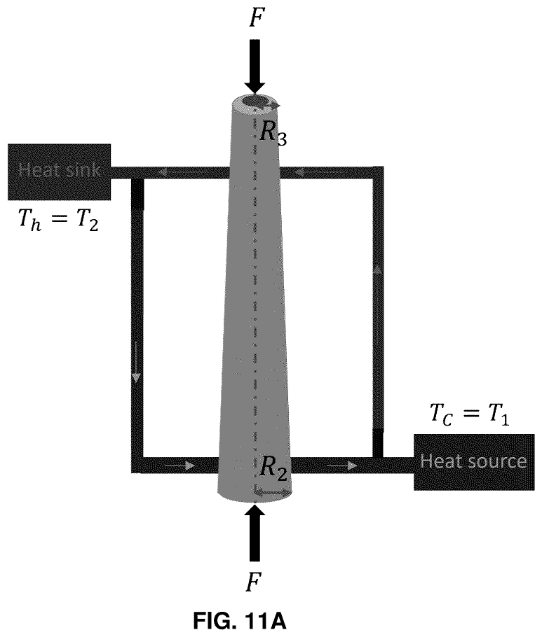

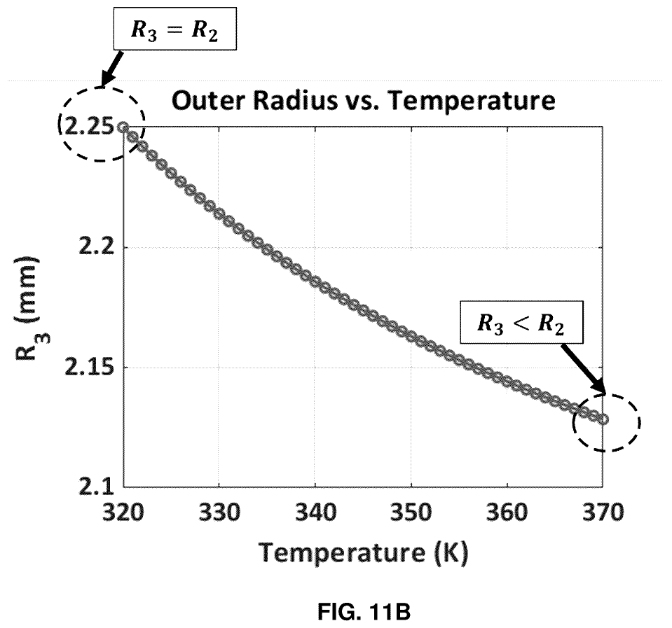

FIG. 10 depicts an illustration of the changes in cross section design according to the Clausius-Clapeyron relation. It shows that when the ambient temperature T₂ increases, a larger critical stress (σ₂) is needed for the material to fully transition into martensite (point B). However, elevating the level of stress might result in significant deformation and reduced efficiency. In order to address this problem, the only viable solution appears to be reducing the cross-sectional area in order to lessen the applied stress on σ₁. In higher ambient temperatures, the stress distribution occurs at a lower level, specifically at point C. To reduce the stress level at higher ambient temperatures, it is important to decrease the cross-sectional area. FIG. 11A illustrates the indirect correlation between the radius and temperature. For this analysis, the inner radius (R₁) of 1.95 mm and the outer radius (R₂) of 2.25 mm at lower temperature ambient are chosen as constant values. The variation of the outer radius of R₃ can be observed in FIG. 11B. The temperature has a direct impact on the stress value needed for a complete transformation as has been explained through Equation (12) to (15).

Certain embodiments of the devices and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices and methods described herein to various usages and conditions. Various changes may be made, and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A method for fabricating a functionally graded structure, the method comprising:
forming a functionally graded structure from a shape memory alloy, and the functionally graded structure having a variation of transformation temperature along a length or a loading direction of the functionally graded structure or a variation of cross-sectional area along the length or a loading direction of the functionally graded structure, wherein the functionally graded structure is configured to be subjected to cyclic loading and unloading to induce phase transformations to promote near-uniform phase transformation across the functionally graded structure.

2. The method of claim 1, wherein the variation of transformation temperature is configured so that a martensite peak temperature and an austenite peak temperature vary continuously or step-wise across the functionally graded structure by an amount corresponding to an expected system temperature span in a thermal management system.

3. The method of claim 1, wherein the functionally graded structure has a first end and second end, the first end configured to be exposed to a first temperature, the second end configured to be exposed to a second temperature, the first temperature is higher than the second temperature, and wherein a lowest martensite start temperature occurs at the second end and a highest austenite start temperature occurs at the first end.

4. The method of claim 1, wherein the variation of cross-sectional area is configured so that stress required to induce phase transformation, when the functionally graded structure is subjected to an expected system temperature span in a thermal management system, remains substantially constant along the length of the functionally graded structure.

5. The method of claim 1, wherein the functionally graded structure has a first end and second end, the first end has a first cross-sectional area, the second end has a second cross-sectional area, and wherein the first cross-sectional area is less than the second cross-sectional area.

6. The method of claim 5, wherein the first cross-sectional area is configured to be exposed to a first temperature, the second cross-sectional area is configured to be exposed to a second temperature, and the first temperature is higher than the second temperature.

7. The method of claim 1, wherein the functionally graded structure is formed using additive manufacturing.

8. The method of claim 1, wherein the functionally graded structure is formed using laser powder bed fusion, directed energy deposition, or conventional powder metallurgy and melting processes.

9. The method of claim 8, wherein process parameters in laser powder bed fusion are varied by modulating laser power, scanning speed, or hatch spacing to create the variation of transformation temperature along the length of the functionally graded structure.

10. The method of claim 1, wherein the functionally graded structure is an elongate member having a channel extending from a first end to a second end of the elongate member, the first end having a first outer diameter and the second end having a second outer diameter, and wherein the first outer diameter is different than the second outer diameter.

11. A thermal management system comprising:
a functionally graded structure comprising a shape memory alloy, and the functionally graded structure having a variation of transformation temperature along a length of the functionally graded structure or a variation of cross-sectional area along the length of the functionally graded structure, wherein the functionally graded structure is configured to be subjected to cyclic loading and unloading to induce phase transformations to promote near-uniform phase transformation across the functionally graded structure.

12. The thermal management system of claim 11, wherein the spatial variation of transformation temperature is configured so that a martensite peak temperature and an austenite peak temperature vary continuously or step-wise across the functionally graded structure by an amount corresponding to an expected system temperature span in the thermal management system.

13. The thermal management system of claim 11, wherein the functionally graded structure has a first end and second end, the first end configured to be exposed to a first temperature, the second end configured to be exposed to a second temperature, the first temperature is higher than the second temperature, and wherein a lowest martensite start temperature occurs at the second end and a highest austenite start temperature occurs at the first end.

14. The thermal management system of claim 11, wherein the spatial variation in cross-sectional area is configured so that stress required to induce phase transformation, when the functionally graded structure is subjected to an expected system temperature span in a thermal management system, remains substantially constant along the length of the functionally graded structure.

15. The thermal management system of claim 11, wherein the functionally graded structure has a first end and second end, the first end has a first cross-sectional area, the second end has a second cross-sectional area, and wherein the first cross-sectional area is less than the second cross-sectional area.

16. The thermal management system of claim 15, wherein the first cross-sectional area is configured to be exposed to a first temperature, the second cross-sectional area is configured to be exposed to a second temperature, and the first temperature is higher than the second temperature.

17. The thermal management system of claim 11, wherein the functionally graded structure is an elongate member having a channel extending from a first end to a second end of the elongate member, the first end having a first outer diameter and the second end having a second outer diameter, and wherein the first outer diameter is different than the second outer diameter.

18. The thermal management system of claim 11, wherein the functionally graded structure is an elongate member having a channel extending from a first end to a second end of the elongate member, the elongate member has an inner diameter and an outer diameter, and wherein the inner diameter remains constant along the elongate member and the outer diameter varies along the elongate member.

19. The thermal management system of claim 11, wherein the thermal management system includes an active regenerator comprising the functionally graded structure and a fluid network, wherein cyclic loading and heat transfer steps are synchronized such that near-uniform phase transformation is achieved during each cycle.

20. The thermal management system of claim 19, wherein the active regenerator includes a shell-and-tube and/or parallel plates configured such that a transformation temperature gradient aligns with the direction of fluid flow from a heat source to a heat sink.
